(19) United States
(12) Patent Application Publication
(10) Pub. No.: US 2015/0195892 A1
(43) Pub. Date: Jul. 9, 2015

(54) LIGHTING DEVICE

(71) Applicant: Electronics and Telecommunications Research Institute, Daejeon (KR)

(72) Inventors: Seong Hee PARK, Daejeon (KR); Jung Sik SUNG, Daejeon (KR); Hyun Chul KANG, Daejeon (KR); In Su KIM, Daejeon (KR); Hyun Joo KANG, Daejeon (KR); Jong Woo CHOI, Daejeon (KR); Tae Gyu KANG, Daejeon (KR)

(21) Appl. No.: 14/590,225

(22) Filed: Jan. 6, 2015

(30) Foreign Application Priority Data
Jan. 8, 2014 (KR) 10-2014-0002401

(51) Int. Cl. H05B 37/02; F21V 29/70; F21V 3/00

(52) U.S. Cl. CPC H05B 37/0272; F21V 3/00; F21V 29/70

(57) ABSTRACT

Provided is a lighting device controlled by a remote lighting control device through wireless communication, including a diffuser unit including a diffuser configured to emit light generated by a light emitting device outwardly and an antenna pattern integrally formed with the diffuser and configured to receive a wireless communication signal for controlling light emission of the light emitting device from the remote lighting control device, a controller configured to receive the wireless communication signal through signal lines electrically connected to the diffuser unit, and a light source module configured to include the light emitting device and control light emission of the light emitting device under the control of the controller.

### CROSS-REFERENCE TO RELATED APPLICATIONS

This application claims priority under 35 U.S.C. §119 to Korean Patent Application No. 10-2014-0002401, filed on Jan. 8, 2014, the disclosure of which is incorporated herein by reference in its entirety.

### TECHNICAL FIELD

The present invention relates to a lighting device, and more particularly, to a lighting device remotely controlled through wireless communication.

### p BACKGROUND

Recently, intelligent-type lighting devices having an RF antenna have come to prominence. Such intelligent-type lighting devices are controlled to receive a radio frequency (RF) signal from a remote area through an RF antenna and perform a particular operation according to the received RF signal.

RF antennas developed so far for lighting devices include an RF antenna protruded to the outside of a housing constituting a lighting device, a chip-type RF antenna implemented on a printed circuit board (PCB), an RF antenna implemented to be disposed on a heat dissipation plate of a lighting device, and the like. A lighting device embedded in a wall may not provide a good appearance aesthetically. Also, obstacle factors such as the ceiling, wall, and the like, may weaken strength of an RF signal, making it difficult to anticipate a reliable operation of such an embedded-type antenna.

### SUMMARY

Accordingly, the present invention provides a lighting device, which performs a particular operation according to a wireless communication signal received from a remote area, capable of increasing reliability of transmission and reception of the wireless communication signal and facilitating designing of a wireless communication antenna for receiving the wireless communication signal.

In one general aspect, a lighting device controlled by a remote lighting control device through wireless communication may include a diffuser unit including a diffuser configured to emit light generated by a light emitting device outwardly and an antenna pattern integrally formed with the diffuser and configured to receive a wireless communication signal for controlling light emission of the light emitting device from the remote lighting control device; a controller configured to receive the wireless communication signal through signal lines electrically connected to the diffuser unit; and a light source module configured to include the light emitting device and control light emission of the light emitting device under the control of the controller.

In another general aspect, a lighting device controlled by a remote lighting control device through wireless communication may include a diffuser unit including a diffuser configured to emit light generated by a light emitting device outwardly and an antenna pattern formed inside the diffuser and configured to receive a wireless communication signal for controlling light emission of the light emitting device from the remote lighting control device; a controller configured to receive the wireless communication signal through signal lines electrically connected to the diffuser unit; and a light source module configured to include the light emitting device and control light emission of the light emitting device under the control of the controller.

### BRIEF DESCRIPTION OF THE DRAWINGS

FIG. 1 is a block diagram of a lighting system according to an embodiment of the present invention.

FIG. 2 is a view illustrating a structure of a lighting device illustrated in FIG. 1.

FIG. 3 is a view illustrating a structure of an antenna pattern provided in a diffuser illustrated in FIG. 2.

FIG. 4 is a view illustrating another example of the antenna pattern illustrated in FIG. 2.

### DETAILED DESCRIPTION OF EMBODIMENTS

Hereinafter, with reference to the drawings embodiments of the present invention will be described in detail. However, the spirit of the present invention is not restricted to the embodiments nor suggested, those of skill in the art to understand the spirit of the invention are within the scope of the same other components are added, changed, deleted, etc., via the present invention or other degeneration approximate included within the scope of the invention, other embodiments can be readily suggested, but this is also included within the scope of the invention that will be thought.

As used herein, the terms are now widely used as a general term used is selected by the applicant for special cases, which terms are arbitrarily chosen in this case the simple names of the terms for carrying out the invention are not described or used in the specific sense information, considering the meaning that would be identified.

Hereinafter, embodiments of the present invention will be described in detail with reference to the accompanying drawings.

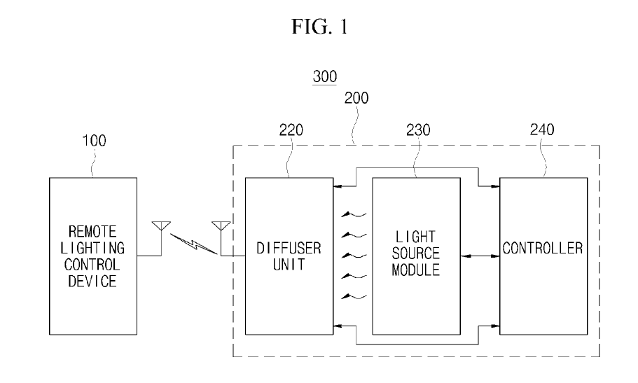

FIG. 1 is a block diagram of a lighting system according to an embodiment of the present invention.

Referring to FIG. 1, the lighting system 300 according to an embodiment of the present invention includes a remote lighting control device 100 and a downlight lighting device 200. The remote lighting control device 100 transmits a wireless communication signal for controlling a particular operation related to turning on or off a light emitting device of the lighting device 200 under the control of a user through wireless communication such as ZigBee wireless communication. The lighting device 200 receives the wireless communication signal, and controls an operation of the light emitting device provided therein to perform a turn-on or turn-off operation according to the received wireless communication signal. To this end, the lighting device 200 includes a diffuser unit 220, a light source module 230, and a controller 240.

The diffuser unit 220 diffuses illumination light radiated from the light source module 230. In addition, the diffuser unit 220 serves as an antenna for receiving a wireless communication signal from the remote lighting control device 100. To this end, the diffuser unit 220 includes a diffuser and an antenna. In other words, the diffuser unit 220 includes an antenna and diffuser configured as one body.

The light source module 230 includes a light emitting device that generates light under the control of the controller 230. Light generated by the light emitting device is radiated through the diffuser unit 220. The light emitting device may be a light emitting diode (LED) but the present invention is not limited thereto.

The controller 240 receives a wireless communication signal from the remote lighting control device 100 through the diffuser unit 220 serving as an antenna and controls an operation of the light emitting device included in the light source module 230 according to the received wireless communication signal.

Hereinafter, the lighting device illustrated in FIG. 1 will be described in detail.

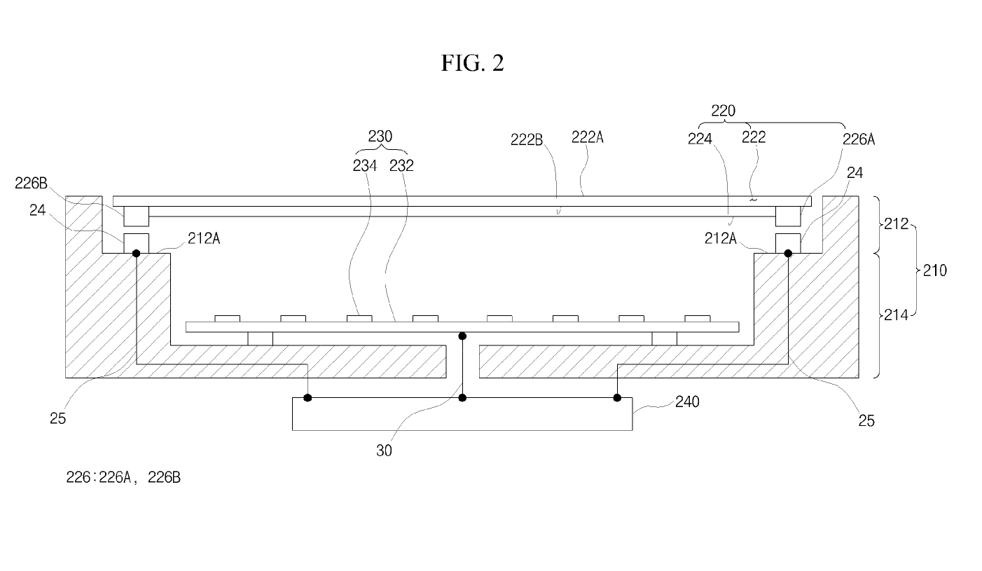

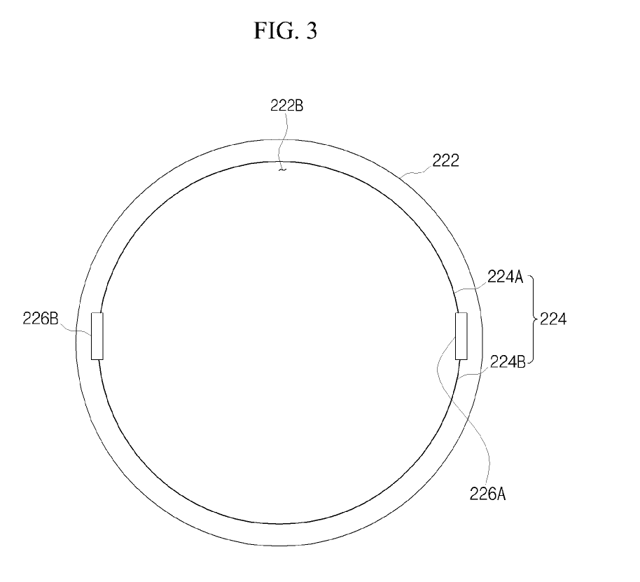

FIG. 2 is a view illustrating a structure of the lighting device illustrated in FIG. 1, and FIG. 3 is a view illustrating a structure of an antenna pattern provided in the diffuser illustrated in FIG. 2.

First, referring to FIG. 2, the lighting device includes a cylindrical heat dissipation frame 210 having an accommodation space, the diffuser unit 220 covering the accommodation space of the heat dissipation frame 210, the light source module 230 accommodated in the accommodation space of the heat dissipation frame 210, and the controller 240 formed below the heat dissipation frame 210 and electrically connected to the diffuser unit and the light source module 230.

The heat dissipation frame 210 is configured to outwardly dissipate heat generated by the light source module 230. The heat dissipation frame 210 may be formed of a metal or resin having excellent heat dissipation efficiency. For example, the heat dissipation frame 210 may include at least one of aluminum (Al), nickel (Ni), copper (Cu), silver (Ag), tin (Sn), and magnesium (Mg). The heat dissipation frame 210 includes an upper end portion 212 with an open upper portion and a body 214 extending along an outer circumference of the upper end portion 212 in a vertical direction. A mounting protrusion 212A is formed in the upper end portion 212 and an end portion of the diffuser unit 220 is fixedly mounted on the mounting protrusion 212A. Terminals 24 electrically connected to the controller 240 are formed on the mounting protrusion 212A. As described hereinafter, an antenna connector 226 is formed in an end portion of the diffuser unit 220. When the end portion of the diffuser unit 220 is fixedly mounted on the mounting protrusion 212A, the terminals 24 and the antenna connector 226 are electrically connected. Thus, the antenna connector 226 may be electrically connected to the controller 240 through the terminals 24.

The diffuser unit 220 includes a diffuser 222 and an antenna pattern 224. The diffuser 222, outwardly radiating light provided from the light source module 230, includes an outer surface 222A exposed to the outside and an inner surface 222B receiving light generated by the light source module 230. The inner surface 222B of the diffuser 222 is coated with colored paint, and the paint may include a diffusion material allowing light passing through the interior of the heat dissipation frame 210 to be diffused from the inner surface 222B of the diffuser 222. A material of the diffuser 222 may be glass or a resin, and in consideration of a weight or external impact, preferably, resins such as plastic, polypropylene (PP), polyethylene (PE), or the like, are used. Surface roughness of the inner surface 222B of the diffuser 222 is greater than that of the outer surface 222A. This is to allow light, which is generated by the light source module and irradiated to the inner surface 222B, to be sufficiently scattered and diffused and outwardly emitted through the outer surface 222A.

The diffuser unit 220 is configured to serve as an antenna, and to this end, the antenna pattern 224 is formed on an inner surface of the diffuser 222 according to a shape of the diffuser 222. The antenna pattern 224 will be described in detail with reference to FIG. 3.

FIG. 3 is a view illustrating a structure of the antenna pattern provided in a diffuser illustrated in FIG. 2. Specifically, FIG. 3 illustrates a configuration of the inner surface 222B of the diffuser 222 viewed at a front side. To help understand, the antenna pattern will be described together with FIG. 2

Referring to FIG. 3, the antenna pattern 224 may be formed on the inner surface 222B of the diffuser 222 and may be configured such that a shadow is not generated when the diffuser 222 radiates light. To this end, the antenna pattern 224 may be formed on the edge of the inner surface 222B, forming a circular line pattern. The antenna pattern 224 may include a semi-circular first pattern 224A and a semi-circular second pattern 224B forming the circular antenna pattern 224 together with the first pattern 222A. The antenna pattern 224 may include two connectors 226A and 226B electrically connecting the first pattern 224A and the second pattern 224B to the terminals 24 formed on the mounting protrusion 212A of the heat dissipation frame 210. Here, the connector 226A electrically connects one end portion of the first pattern 224A and one end portion of the second pattern 224B to one terminal 24 formed on the mounting protrusion 212A of the heat dissipation frame 210, and the connector 226B electrically connects the other end portion of the first pattern 224A and the other end portion of the second pattern 224B to the other terminal 24 formed on the mounting protrusion 212A of the heat dissipation frame 210.

Referring back to FIG. 2, the light source module 230 is turned on and off under the control of the controller 240 and radiates light adjusted brightness toward the inner surface 222b of the diffuser 222. To this end, the light source module 230 may include a board 232 accommodated in the accommodation space formed within the heat dissipation frame 210, and at least one light emitting device 234 is disposed on the board 232. The board 232 may be a printed circuit board (PCB) on which a circuit pattern is printed on an insulator, a metal core PCB, a flexible PCB, a ceramic PCB, or the like. Also, the board 232 may be a chip-on-board type PCB on which an unpackaged LED chip is directly bonded. The board 2332 may be formed of a material effectively reflecting light or may have a surface in a color effectively reflecting light, for example, white color, a silver color, or the like. At least one light emitting device 234 may be disposed on the board 232, and here, the at least one light emitting device 234 may be an LED chip emitting red, green, blue light, or UV light. Although not shown in FIG. 2, a lens may be additionally formed above the light emitting device 234. The lens may be disposed above the board 232 to cover the light emitting device 234. The lens adjusts a beam angle or a direction of light emitted from the light emitting device 234. Here, the lens may have a hemispherical shape and the interior of the lens may be entirely filled with a light-transmissive resin such as a silicon resin or an epoxy resin without an empty space.

As illustrated in FIG. 3, the controller 240 controls a particular operation, such as ON/OFF controlling and brightness controlling, of the light emitting device formed on the board 232 according to a wireless communication signal received through the antenna pattern 224 formed on the inner surface 222B of the diffuser 222. To this end, the controller 240 is electrically connected to the terminals 24 formed on the mounting protrusion 212A through antenna signal lines 25 and electrically connected to the circuit pattern printed on the board 232 of the light source module 230 through a control signal line 30.

Accordingly, when the diffuser unit 220 is fixedly mounted on the mounting protrusion 212A of the heat dissipation frame 210, the connectors 226A and 226B of the diffuser 222 are electrically connected to the terminals 24 formed on the mounting protrusion 212A, whereby the controller 240 may receive a wireless communication signal from the remote lighting control device 100 through the antenna signal lines 25 and deliver a control signal for controlling ON/OFF operation or brightness of the light emitting device 234 to the light source module 230 through the control signal line 30.

As described above, the lighting device according to the embodiment of the present invention wirelessly communicates with the remote control device through the antenna integrally provided with the diffuser, even though the lighting device is installed to be embedded in a structure such as the ceiling, wall, or the like, there is no need to install a separate antenna outside of the lighting device, resolving the problem of marring the appearance and eliminating a degradation of signal quality of a wireless communication signal due to an obstacle factor such as the ceiling, wall, or the like.

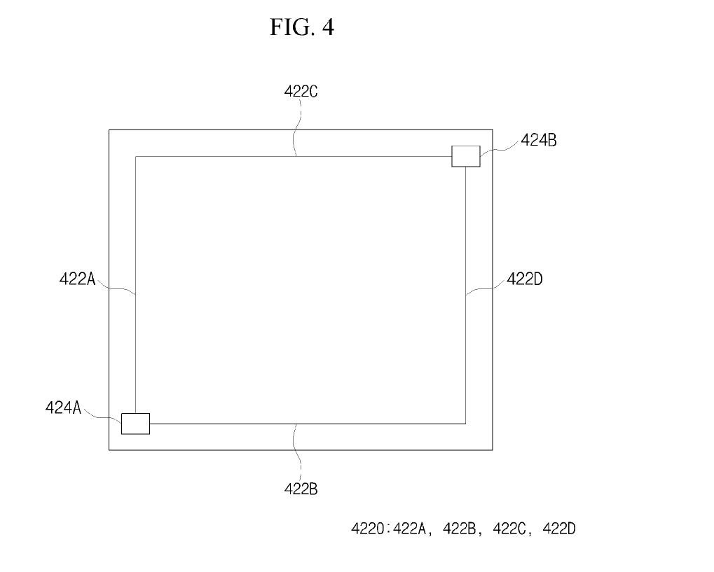

In FIG. 3, the circular antenna pattern formed on the circular diffuser is illustrated as an example, but the present invention is not limited to the lighting device having the circular diffuser and may be applied to any type of diffuser as can be understood by a person skilled in the art through the above description. For example, in case of a lighting device having a quadrangular diffuser, as illustrated in FIG. 4, an antenna may be configured as an antenna pattern having a quadrangular shape identical to that of the diffuser. In other words, an antenna pattern formed in the quadrangular diffuser may include a “ [symbol] ”-shaped pattern and a “ [symbol] ”-shaped pattern configured to form a quadrangular antenna pattern together with the “ [symbol] ”-shaped pattern. The “ [symbol] ”-shaped pattern may include a first straight pattern 422A formed on the inner edge of the diffuser and a second straight pattern 422B formed to be perpendicular to the first pattern 422A. One end portion of the first pattern 422A and one end portion of the second pattern 422B are electrically connected to the terminal 24 formed on the mounting protrusion 212A through a connector 424A. The “ [symbol] ”-shaped pattern includes a third pattern 422C formed on the inner edge of the diffuser and a fourth pattern 422D formed to be perpendicular to the third pattern 422C. One end portion of the third pattern 422C and one end portion of the fourth pattern 422D are electrically connected to the terminal 24 formed on the mounting protrusion 212A illustrated in FIG. 2 through a connector 424B.

In this manner, since the antenna pattern provided in the lighting device is formed on an inner surface of the diffuser, although the lighting device according to the embodiment of the present invention is installed to be embedded in a structure such as the ceiling, wall, or the like, a degradation of signal quality due to an obstacle factor such as the ceiling, wall, or the like, may be minimized Also, since the antenna pattern according to the embodiment of the present invention has a shape identical to that of the diffuser and disposed on the edges of the diffuser, it does not mar the appearance of the surroundings.

Also, since the lighting device according to the embodiment of the present invention wirelessly communicates with the remote control device through the antenna integrally provided with the diffuser, even though the lighting device is installed to be embedded in a structure such as the ceiling, wall, or the like, there is no need to install an additional antenna outside of the lighting device, resolving the problem of marring the appearance and eliminating a degradation of signal quality of a wireless communication signal due to an obstacle factor such as the ceiling, wall, or the like.

The foregoing embodiments and advantages are merely exemplary and are not to be considered as limiting the present disclosure. It will be apparent to those skilled in the art that modifications and variations can be made without departing from the spirit and scope of the invention. For example, in the present disclosure, it is illustrated that the antenna pattern is formed on an inner surface of the diffuser, but the antenna pattern may be formed inside the diffuser. The antenna pattern formed inside the diffuser may be implemented through various manufacturing processes. The diffuser having an antenna pattern therein may be simply implemented through processes of preparing a first circular or quadrangular diffuser having first surface roughness, forming an antenna pattern having a shape identical to that of the first diffuser on the edges of the first diffuser, and subsequently compressively molding the first diffuser and a second diffuser having a shape identical to that of the first diffuser and second surface roughness greater than the first surface roughness. Thus, this description is intended to be illustrative, and not to limit the scope of the claims. Also, although an embodiment has not been described in the above disclosure, it should be extensively construed within the scope of the technical concept defined in the claims. And, various changes and modifications that fall within the scope of the claims, or equivalents of such scope are therefore intended to be embraced by the appended claims

What is claimed is:

1. A lighting device controlled by a remote lighting control device through wireless communication, the lighting device comprising:
a diffuser unit including a diffuser configured to emit light generated by a light emitting device outwardly and an antenna pattern integrally formed with the diffuser and configured to receive a wireless communication signal for controlling light emission of the light emitting device from the remote lighting control device;
a controller configured to receive the wireless communication signal through signal lines electrically connected to the diffuser unit; and
a light source module configured to include the light emitting device and control light emission of the light emitting device under the control of the controller.

2. The lighting device of claim 1, wherein the antenna pattern has a shape identical to that of the diffuser when viewed from the front side.

3. The lighting device of claim 1, wherein the diffuser has an outer surface exposed outwardly and an inner surface receiving light generated by the light emitting device, and the antenna pattern is formed on the edges of an inner surface of the diffuser.

4. The lighting device of claim 3, further comprising a heat dissipation frame having a body with an upper end portion on which the diffuser unit is mounted and an accommodation space accommodating the light source module, wherein the heat dissipation frame includes a mounting protrusion allowing the edges of the diffuser to be mounted thereon; and two terminals electrically connected to the signal lines, formed on the mounting protrusion, and electrically connected to the antenna pattern.

5. The lighting device of claim 4, wherein when the diffuser has a circular shape, the antenna pattern includes a first semi-circular line pattern; a second semi-circular line pattern; a first connector electrically connecting one end portion of the first line pattern and one end portion of the second line pattern to one of the two terminals; and a second connector electrically connecting the other end portion of the first line pattern and the other end portion of the second line pattern to the other of the two terminals.

6. The lighting device of claim 4, wherein when the diffuser has a quadrangular shape, the antenna pattern includes: a first straight line pattern; a second straight line pattern extending in a direction perpendicular to an extending direction of the first line pattern; a first connector electrically connecting one end portion of the first line pattern and one end portion of the second line pattern to one of the two terminals; a third straight light pattern formed to be parallel to the second line pattern; a fourth straight line pattern formed to be parallel to the first line pattern; and a second connector electrically connecting one end portion of the third line pattern and one end portion of the fourth line pattern to the other of the two terminals.

7. A lighting device controlled by a remote lighting control device through wireless communication, the lighting device comprising:
a diffuser unit including a diffuser configured to emit light generated by a light emitting device outwardly and an antenna pattern formed inside the diffuser and configured to receive a wireless communication signal for controlling light emission of the light emitting device from the remote lighting control device;
a controller configured to receive the wireless communication signal through signal lines electrically connected to the diffuser unit; and
a light source module configured to include the light emitting device and control light emission of the light emitting device under the control of the controller.

8. The lighting device of claim 7, wherein the antenna pattern has a shape identical to that of the diffuser when viewed from the front side.
